(19) United States
(12) Patent Application Publication
(10) Pub. No.: US 2025/0104716 A1
(43) Pub. Date: Mar. 27, 2025

(54) VOCAL PROFILES FOR VOICE INPUT INTERPRETATION IN MULTI-USER ENVIRONMENTS

(71) Applicant: Ivanti, Inc., South Jordan, UT (US)

(72) Inventors: Ian Hughes, Daresbury (GB); Thomas Eaton, Reading (GB); Matthew Pritchard, Daresbury (GB); Taylor Sorensen, American Fork, UT (US); James Brian, Daresbury (GB)

(73) Assignee: Ivanti, Inc., South Jordan, UT (US)

(21) Appl. No.: 18/891,713

(22) Filed: Sep. 20, 2024

Related U.S. Application Data
(60) Provisional application No. 63/584,777, filed on Sep. 22, 2023.

(51) Int. Cl. G10L 17/04; G10L 17/02; G10L 17/06; G10L 17/24

(52) U.S. Cl. CPC G10L 17/04; G10L 17/02; G10L 17/06; G10L 17/24

(57) ABSTRACT

An embodiment includes a method of vocal profile generation and implementation that includes causing display of a prompt for a user that represents an input value of a processing engine. The method includes obtaining a first spoken pronunciation from the user that corresponds to the prompt. The method includes generating a vocal profile based on the first spoken pronunciation that provides a basis for interpretation of vocal input received on distributed devices. The method includes storing the vocal profile at a data storage with other vocal profiles generated for users. The method includes obtaining identifier information that indicates that the user is operating a distributed device. Responsive to the identifier information, the method includes retrieving the vocal profile and loading it onto the distributed device such that obtained vocal input is interpreted according to the vocal profile prior its communication as an input value to the processing engine.

### CROSS-REFERENCE TO RELATED APPLICATION

This application claims priority to and the benefit of U.S. Provisional Application No. 63/584,777, filed Sep. 22, 2023, which is incorporated herein by reference in its entirety.

### FIELD

The present disclosure generally relates to generation and implementation of vocal profiles. In particular, some embodiments relate to implementation of the vocal profiles to interpret voice input to computer systems in multi-device industrial and supply chain environments.

### BACKGROUND

An industrial environment (e.g., a warehouse, a factory, a plant, etc.) may include shelves, boxes, containers, or other storage locations in which items are placed at least temporarily in the industrial environment. Operators in the industrial environment may be instructed to perform operations that involve changing locations of the items, adding items to the industrial environment, removing items from the industrial environment, etc. For example, the operators may move specific items to a loading dock responsive to receiving a request for procurement of the specific items. Some industrial environments may include operators performing manual tasks of movement of items within the industrial environment. Additionally or alternatively, industrial environments may include automated transportation of items through use of automated conveyors, pallet movers, cranes, etc.

An operator may use a portable computing device to facilitate the performance of the operations. For example, the operator may use a scanner device or a rugged device to electronically track addition and removal of items. Additionally, the operator may use a portable computer terminal to access information to help navigate the industrial environment. In some industrial environments, a portable computing device may be designated for use by multiple operators. These industrial environments may require each of the operators to enter user credentials to enable its use. The user credentials correspond to each of the operators. The user credentials log the operator into the portable computing device. In these and other industrial environments, after the operator is logged into the portable computing device, information relevant to the tasks assigned to the operator may be presented. Additionally, metrics regarding operations carried out by the operator may be gathered.

The operators working with the portable computing device may interact with the portable computing device differently according to different tasks assigned, technical competence, personal preferences, or other differences between the operators. To account for the differences between the operators, user credentials associated with the operators may be used to tailor the portable computing device to the operator currently using the portable computing device.

Some portable computing devices may enable voice or audio input. For instance, the operator is able to speak a command or an input instead of manually entering (e.g., via keystrokes or icon selection) data. The audio input capability provides an improvement over manual data entry as far as speed. However, voice input is error prone and often least to inaccurate data being entered into the portable computing device. Reception and interpretation of voice input is particularly difficult in environments with operators from differing backgrounds, accents, mother languages, etc. Conventional systems attempt to solve this problem through machine learning applications and other best-guess translators. In general, these conventional systems attempt to fit audio input to a known or previous input or to a voice model. These conventional systems often involve large storage overhead and complex machine translators that are implemented throughout a system. Accordingly, there is a need to improve voice data interpretation to reduce processing overhead and maintain accurate data capture and processing.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method of vocal profile generation and implementation. The method may include causing display of a prompt for a first user. The prompt may represent an input value of a processing engine executable by multiple distributed devices. The method may include obtaining a first spoken pronunciation from the first user that corresponds to the prompt. The method may include generating a first vocal profile based at least partially on the first spoken pronunciation. The first vocal profile may provide a basis for interpretation of vocal input received on any distributed device of the plurality of distributed devices. The method may include storing the first vocal profile at a data storage with multiple vocal profiles generated for a plurality of users. The method may include obtaining, from the first distributed device, identifier information sufficient to indicate that the first user is operating a first distributed device of the distributed devices. Responsive to the identifier information, the method may include retrieving the first vocal profile from the data storage. The method may include loading the first vocal profile onto the first distributed device such that vocal input obtained at the first distributed device during its operation by the first user is interpreted according to the first vocal profile prior to being communicated as an input value to the processing engine of the first distributed device.

According to another aspect of an embodiment, another method of vocal profile generation and implementation. The method may include displaying, at a first distributed device of a plurality of distributed devices, a prompt for a first user. The prompt may represent an input value of a processing engine executable at the distributed device. The method may include obtaining, at the first distributed device, a first spoken pronunciation from the first user that corresponds to the prompt. The method may include generating, by the first distributed device, a first vocal profile based at least partially on the first spoken pronunciation. The first vocal profile may provide a basis for interpretation of vocal input received by any of the plurality of distributed devices. The method may include obtaining, at a second distributed device, identifier information sufficient to indicate that the first user is operating the second distributed device. Responsive to the identifier information, the method may include retrieving the first vocal profile. The method may include loading the first vocal profile onto the second distributed device. The method may include obtaining, at the second distributed device, a vocal input from the first user. The method may include interpreting, by the second distributed device, the vocal input according to the first vocal profile, the interpreting may include determining whether the vocal input or a text-based representation of the vocal input matches the first spoken pronunciation. Responsive to the vocal input or a text-based representation of the vocal input matching the first spoken pronunciation, the method may include returning an output value corresponding to the input value of the prompt. The method may include providing the output value as an input value to the processing engine.

A further aspect of an embodiment includes a non-transitory computer-readable medium having encoded therein programming code executable by one or more processors to perform or control performance at least a portion of the methods described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a block diagram of an example operating environment in which some embodiments of the present disclosure may be implemented;

FIG. 2 is a block diagram of an example embodiment of a vocal profile process that may be implemented in the operating environment of FIG. 1;

FIG. 3A is a block diagram of a single-device environment in which the process of FIG. 2 may be implemented;

FIG. 3B is a block diagram of a multi-device environment in which the process of FIG. 2 may be implemented;

FIGS. 4A and 4B are a flow chart of an example method of vocal profile generation and implementation;

FIGS. 5A and 5B are a flow chart of an example method of vocal profile generation and implementation; and

FIG. 6 illustrates an example computer system configured for vocal profile generation and implementation,
all in accordance with at least one embodiment of the present disclosure.

### DETAILED DESCRIPTION

Embodiments of the present disclosure relate to systems and methods of configuring and deploying vocal profiles for voice data interpretation. The vocal profiles are generated and stored such that the vocal profiles are accessible to multiple computing devices. The vocal profiles are unique to a user or an operator who performs tasks using one of the computing devices in a productivity management system. The vocal profile may be generated based on an initial set of pronunciation data that may be customized to an application or environment. The vocal profile may be loaded to the computing device responsive to the operator logging into one of the computing devices. The vocal profile enables interpretation and adaptation of voice input received by the operator, which improves accuracy of the voice input without significantly increasing computing overhead to perform the interpretation.

For instance, in some environments, operators may pronounce words differently because of regional accents, native languages, etc. Accordingly, voice input received in these environments may differ significantly from common pronunciations, which may be anticipated by grammar files, and may differ significantly from one operator to another. Consequently, in conventional environments multiple grammar files or large-scale voice recognition software may be implemented to accurately account for these differences. The increased number of grammar files and/or large-scale voice recognition software introduce significant computing overhead.

The vocal profiles described in the present disclosure may be integrated into the productivity management systems to interpret and/or adjust voice data received by the distributed devices. The vocal profiles provide interpretation at a user-level or an operator-level of granularity, which may be customized to an application or an environment. Moreover, the vocal profiles are individually generated, which provide simple, interpretative functions without the need for large-scale interpretive language models. The vocal profiles accordingly improve the productivity management systems while minimizing computational overhead.

For instance, some embodiments of the present disclosure may be implemented in a productivity management system having two or more distributed computing devices (hereinafter, “distributed device” or “distributed devices”) that may be used by two or more users. The two or more users may not be uniquely associated with any of the distributed devices such that any one of the users may use any of the distributed devices. In these and other embodiments, one or more prompts may be generated. The prompts may be generated to include examples of input that are common or expected in a particular environment or application.

The prompts may be displayed to a first user. The first user may provide a spoken pronunciation that corresponds to the prompts. The spoken pronunciation is processed to generate a vocal profile that is specific to the first user. The prompts may then be displayed to one or more additional users and spoken pronunciations are received from each of the one or more users. The spoken pronunciations may be used to generate vocal profiles of each of the one or more additional users. The vocal profiles may be stored in a data storage, which may be remote to distributed devices. After the vocal profile is generated for the first user, the first user may log into a first distributed device. Responsive to the log in event, the vocal profile of the first user is loaded to the first distributed device. The vocal profile may be used to interpret and/or adjust voice input received by the first distributed device. For instance, the voice input may be interpreted to fit one of the expected input prior to being communicated to an operational module of the first distributed device. Similarly, the first user may log into any of the other distributed devices. Responsive to the log-in event, the vocal profile of the first user may be loaded at the distributed device to enable local interpretation of voice input at the distributed device. Similarly still, another of the users, e.g., a second user, may log in to the first distributed device. Responsive to the log in event, the vocal profile of the second user may be loaded at the first distributed device. Voice input received after the vocal profile of the second user is loaded may be interpreted according to the loaded vocal profile.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of some example configurations of the systems and methods.

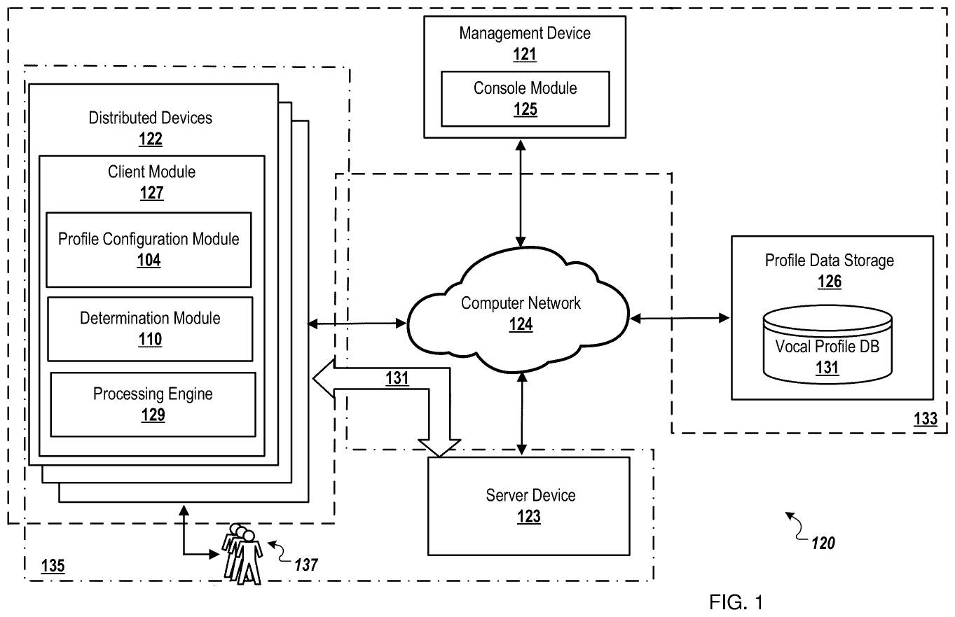

FIG. 1 is a block diagram of an example operating environment 120 in which some embodiments of the present disclosure may be implemented. In the operating environment 120, vocal profiles may be generated that are used to interpret vocal input. The vocal profiles may be implemented to accommodate for variations in language such as accent, dialect, speech impairment, first language, grammar, lexicon, and the like. The vocal profiles may be unique or substantially unique to each of multiple users 137 and generated based on spoken pronunciations obtained from the users 137 responsive to prompts. The vocal profiles are loaded to distributed devices 122 to provide user-level interpretation as vocal input is received. The vocal profiles allow the users 137 to use any of the distributed devices 122 effectively. Moreover, the vocal profiles may enable the distributed devices 122 to operate in an environment in which the users 137 have multiple variations in language.

The operating environment 120 includes a productivity management network 133 that is implemented with a supply chain management network 135. The productivity management network 133 is generally indicated by a dashed border (e.g., ‘- - -’ in FIG. 1) and the supply chain management network 135 is generally indicated by a dash-dot border (e.g., ‘-⋅-’ in FIG. 1). Distributed devices 122 are included in both the productivity management network 133 and the supply chain management network 135. The distributed devices 122 are operated by one or more of the users 137 to perform operations related to movement and organization of items in a supply chain. The productivity management network 133 is implemented with the supply chain management network 135 to improve usability and efficiency of the operations.

For instance, the supply chain management network 135 may be implemented to track items as they move through a supply chain such as from a manufacture facility to a warehouse, then to a delivery truck, and then to a store or within a store from a warehouse to a shelf and then to a consumer. The supply chain management network 135 is deployed to track items as the items move through a series or set of operations.

The productivity management network 133 may be deployed “on top of” the supply chain management network 135. For instance, in the supply chain management network 135, the server device 123 and/or software implemented thereon or thereby may centrally track data 131 input from distributed devices 122. The supply chain management network 135 may implement a telnet protocol (e.g., Telnet) or another similar data communication protocol (collectively, telnet protocols) as a basis of data communication between the distributed devices 122 and the server device 123. The telnet protocols may have limited functionality such as uncommon or user-hostile user interface functionality, restricted data entry functionality, and rigid display features. To improve data communication via telnet protocols, the productivity management system 133 may be implemented. The productivity management system 133 may improve the user interface, optimize data entry, and improve display features and functions. Additionally, the productivity management system 133 may harvest and process data entered during performance of the operations to provide metrics, recommendations, and oversight regarding operational efficiency.

In the embodiment of FIG. 1, the users 137 perform operations using the distributed devices 122. A portion of data and commands entered into the distributed devices 122 may be vocal input. Generally, vocal input is spoken by one of the users into a microphone or another audio sensor that is communicatively connected to the distributed device 122. The vocal input may be one or more words that quantify a characteristic of a process. For instance, the vocal input may be “one, two, three, etc.” Additionally or alternatively, the vocal input may include a command. For instance, one of the users 137 may state “next” to proceed to a next screen or “end” to end an operation.

The users 137 may not be uniquely associated with one of the distributed devices 122. For instance, a first user of the users 137 may select a first distributed device of the distributed devices 122 for a shift or for a particular set of operations. Later (e.g., for a subsequent shift), the first user may select a second distributed device of the distributed devices 122. Additionally, a second user of the users 137 may select the first distributed device. In some embodiments, to operate one of the distributed devices 122, the users 137 may enter user credentials to log into the distributed device 122. Accordingly, in the operating environment 120 of FIG. 1, there is flexibility regarding which of the users 122 is operating one of the distributed devices 122. However, this flexibility may introduce difficulties in interpretation of vocal input. For instance, the language of the users 137 may differ, thus vocal input from at least a subset of the users 137 may not be interpreted correctly because of language variations. The operating environment 120 implements vocal profiles that are generated based on spoken pronunciations of the users 137. The vocal profile of one of the users 137 may be loaded to any of the distributed devices 122 responsive to a login event. Vocal input received by the user may be interpreted based on the loaded vocal profile, which is specifically generated for the user. The vocal profiles may improve the operation of the distributed devices 122 in the operating environment 120 or other suitable operating environments. The vocal profiles enable multi-user device compatibility. For instance, the vocal profiles may provide interpretation of vocal input at a user-level of granularity. Moreover, the vocal profiles may substitute for large-scale language models that require substantial computing resources and are error prone.

The operating environment 120 includes a management device 121, the distributed devices 122, profile data storage 126, and the server device 123 (collectively, “environment components”). The environment components may communicate data and information via a communication network 124 to enable generation and use of the vocal profiles. Each of the environment components are described in the following paragraphs.

The communication network 124 may include one or more wide area networks (WANs) and/or local area networks (LANs) that enable the environment components to communicate with one another. In some embodiments, the communication network 124 may include the Internet in which communicative connectivity between the components of the operating environment 120 is formed by logical and physical connections between multiple WANs and/or LANs. Additionally or alternatively, the communication network 124 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The communication network 124 may also include servers that enable one type of network to interface with another type of network.

The server device 123 and the distributed devices 122 are included in the supply chain management network 135. The server device 123 includes a hardware-based computing device. The server device 123 may be a centralized repository and management program that communicates data 131 with the distributed devices 122. In some embodiments, the data 131 may be communicated via telnet protocol. For instance, the server device 123 may be configured as a telnet server in these and other embodiments. The data 131 may include a user interface into which information may be entered. The distributed devices 122 may include a scanner device, which enters information into the user interface by scanning a barcode. The information from the scanner device may be communicated as the data 131 to the server device 123. The data 131 may be communicated via the communication network 124. Additionally, in some embodiments at least a portion of the distributed devices 122 may communicate a portion of the data 131 via a dedicated wired communication network.

The productivity management network 133 includes the management device 121, the profile data storage 126, and the distributed devices 122. As introduced above, the productivity management network 133 is implemented with the supply chain management network 135 to improve usability and efficiency of the operations. A feature of the productivity management network 133 is vocal profile generation and implementation as described herein.

The profile data storage 126 may include computer-readable storage media for carrying or having computer-executable instructions or data structures stored thereon (e.g., memory 612 of FIG. 6). The profile data storage 126 may include a vocal profile database 131. The vocal profile database 131 may be configured to store vocal profiles generated for the users 137. The vocal profiles in the vocal profile database 131 may be accessible by the distributed devices 122 and/or the management device 121. For instance, in some embodiments, the vocal profiles of the vocal profile database 131 may be retrieved by the distributed devices 122 responsive to a log in event at the distributed device by one of the users 137. For instance a first user may enter user credentials to log into a first distributed device. Responsive to the log in event, the first distributor device may retrieve a user provide of the first user from the vocal profile database 131 of the profile data storage 126.

The management device 121 may include hardware based computing system that is configured to communicate with other environment components via the communication network 124. The management device 121 may include a console computing device such as a laptop, desktop computer, etc. In some embodiments, the management device 121 may be a single server, a set of servers, a virtual device, or a virtual server in a cloud-base network of servers. In these and other embodiments, console module 125 may be spread over two or more cores, which may be virtualized across multiple physical machines.

The management device 121 may include a console module 125. The console module 125 may enable configuration of operations performed by client module 127 implemented at the distributed devices 122. For instance, the console module 125 may enable customization of buttons and fields displayed at the distributed devices 122. Additionally, the console module 125 may enable definition of prompts or other profile configuration data. In some embodiments, the prompts may include anticipated or common input received by the distributed devices 122. For instance, the supply chain management network 135 may involve the users 137 picking items from a warehouse. Picking operations may receive input that indicates a number or a quantity of items pulled from shelves. Accordingly, the prompts may include numbers (e.g., 1, 2, 3, 4, etc.). Additionally or alternatively, the supply chain management network 135 may involve the users 137 relocating items from a first location to a second location. Relocation operations may receive names or identifiers of the first and the second locations. Accordingly, the prompt may include the names or identifiers for the locations (e.g., “east warehouse,” “west warehouse,” “rear lot,” etc.). As described more in the following paragraphs, the prompts may be displayed to one of the users 137 to obtain spoken pronunciations, which form the basis of vocal profiles used in the interpretation of vocal input.

Additionally, in some embodiments, the client module 127 may be configured to generate and implement the vocal profiles. For instance, the console module 125 may be configured to cause display of the prompt for a first user. The console module 125 may cause display of the prompt at one of the distributed devices 122. The console module 125 may obtain a first spoken pronunciation from the first user that corresponds to the prompt. For instance, the first user may speak the first spoken pronunciation into one of the distributed devices 122. The console module 125 may generate a first vocal profile based at least partially on the first spoken pronunciation. Some additional details of the profile generation are provided elsewhere herein. The console module 125 may store the first vocal profile at the profile data storage 126 in the vocal profile database 131. After the vocal profile is generated for the first user, the console module 125 may obtain identifier information from one of the distributed devices 122. The identifier information may be user credentials, log in information or any other information sufficient to indicate that the first user is operating the distributed device 122. Responsive to the identifier information, the console module 125 may retrieve the vocal profile of the first user from the profile data storage 126. The console module 125 may load or instruct the distributed device 122 to load the vocal profile of the first user onto the distributed device 122. When the vocal profile of the first user is loaded to the distributed device 122, vocal input obtained at the distributed device 122 during its operation is adjusted or interpreted according to the vocal profile prior to being communicated to a processing engine 129 as an input value.

The distributed devices 122 may include hardware based computing systems that are configured to communicate with other environment components via the communication network 124. The distributed devices 122 may include a computing device configured to perform operations in the supply chain management network 135. For instance, the distributed devices 122 may include a scanner device, a rugged device, or a mobile or smart device, which may include a scanner. The distributed devices 122 may include, have integrated, or be coupled to an audio sensor such as a microphone. The audio sensor is configured to receive vocal input from the users 137 such that the vocal input is received by the distributed devices 122. In some embodiments, the distributed devices 122 may be computer devices used in an industrial setting, such as a warehouse environment. In these and other embodiments, the distributed devices 122 may be scanner devices used to facilitate warehouse operations.

The distributed devices 122 include a client module 127. The client module 127 is configured to implement operations defined by the console module 125. The client module 127 may include a profile configuration module 104, a determination module 110, and a processing engine 129. The profile configuration module 104 and the determination module 110 may be configured to generate and implement vocal profiles. Some additional details of the profile configuration module 104 and the determination module 110 are provided below.

The processing engine 129 may be configured to perform one or more productivity functions on the distributed devices 122. For example, the processing engine 129 may display user interfaces defined at the console module 125. Additionally, the processing engine 129 may convert data between protocols (e.g., between telnet protocols and HTML). The vocal profiles are used to the interpret voice input prior to use by the processing engine 129.

In some embodiments, the profile configuration module 104 may be configured to generate vocal profiles for the users 137. As discussed above, in some embodiments, the console module 125 may implement one or more of the operations attributed to the profile configuration module 104. The profile configuration module 104 may receive and display the prompt. In some embodiments, the console module 125 may communicate the prompt to the distributor devices 122 such that the prompt may be displayed to a first user. The profile configuration module 104 may obtain a spoken pronunciation from the first user that corresponds to the prompt. The profile configuration module 104 may generate a vocal profile locally at least partially based on the spoken pronunciation. Alternatively, the profile configuration module 104 may communicate the spoken pronunciation to the management device 121, which may generate the vocal profile for the first user at least partially based on the spoken pronunciation.

After the vocal profile is generated, the client module 127 may receive identifier information sufficient to indicate that the first user is operating one of the distributed devices 122. In some embodiments, the identifier information is received at the processing engine 129. The identifier information may be communicated to the console module 125, the profile configuration module 104, the determination module 110, or some combination thereof. In the depicted embodiment, the identifier information may be obtained by the profile configuration module 104. Responsive to the identifier information, profile configuration module 104 may retrieve the generated vocal profile for the first user. The profile configuration module 104 may load the generated vocal profile. For instance, the profile configuration module 104 may load the generated vocal profile onto the determination module 110.

The determination module 110 may obtain vocal input from the first user. The determination module 110 may determine whether the vocal input matches or substantially matches the spoken pronunciation. As used herein “substantially matches” indicates that there exist sufficient similarities between the vocal input and the spoken pronunciation that the determination module 110 categorizes the vocal input and the spoken pronunciation as equivalent. The spoken pronunciation may not be an exact match. There is variation each time the users 137 speak. A substantial match may be with 95% similar, 98% similar, 99% similar, etc. Responsive to the vocal input matching the spoken pronunciation, returning an output value. The output value may correspond to the first input value of the prompt. The determination module 110 may provide the output value as an input value to the processing engine 129.

In the embodiment of FIG. 1, the productivity management network 133 may include the client module 127 and the console module 125. In the embodiment of FIG. 1, the client module 127 is included on the distributed devices 122 and the console module 125 is included on the management device 121. In some embodiments, the client module 127 and/or the console module 125 or operations attributed thereto may be distributed between one or more components of the productivity management network 133.

The console module 125, the client module 127, and components thereof may be implemented using hardware including a processor, a microprocessor (e.g., to perform or control performance of one or more operations), a field-programmable gate array (FPGA), or an application-specific integrated circuit (ASIC). In some other instances, the console module 125, the client module 127, and components thereof may be implemented using a combination of hardware and software. Implementation in software may include rapid activation and deactivation of one or more transistors or transistor elements such as may be included in hardware of a computing system (e.g., the distributed devices 122 or the management device 121 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 120 without departing from the scope of the present disclosure. For example, the operating environment 120 may include one or more distributed devices 122, one or more management devices 121, one or more server devices 123, one or more data storages 126, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

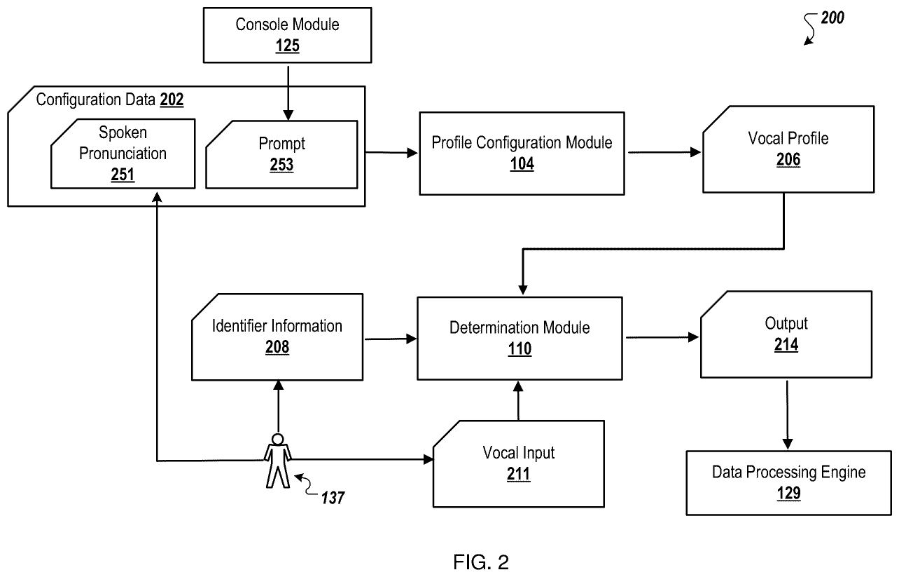

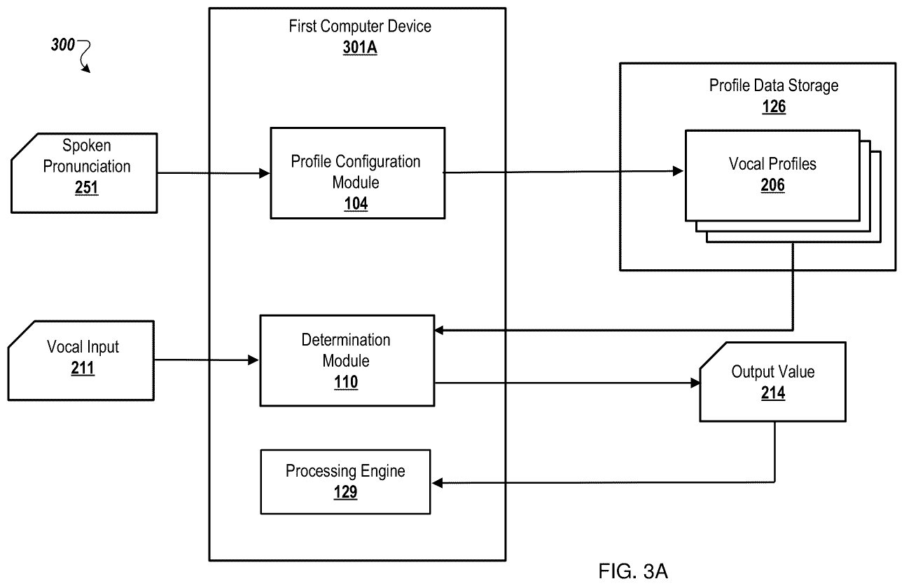

FIG. 2 is a block diagram of an example embodiment of a vocal profile process 200 (process 200) that may be implemented in the operating environment 120 of FIG. 1 or other suitable environments. The process 200 includes an example vocal profile configuration operation and an example vocal profile implementation operation. The process 200 includes the profile configuration module 104, the determination module 110, one of the users 137, and the processing engine 129 described with reference to FIG. 1. In some embodiments, other modules or devices may be implemented to perform one or more portions of the process 200.

The profile configuration module 104 may be configured to obtain configuration data 202 and output a vocal profile 206. The configuration data 202 may include a prompt 253 and a spoken pronunciation 251. The prompt 253 may be communicated from the console module 125. For instance, the prompt 253 may be defined at the console module 125 to reflect anticipated vocal input (e.g., 211). In general, the prompt 253 may include an alphanumerical symbol, a phrase, a word, a symbol, or another suitable icon recognizable by the user. The prompt 253 may correspond to one or more particular inputs to a program (e.g., the processing engine 129) executed by a device implementing the vocal profile 206. For instance, with combined reference to FIGS. 1 and 2, the supply chain management network 135 may implement the distributed devices 122 to execute a supply chain management program. In this example, the distributed devices 122 may be configured to receive input indicating a number of a scanned item on a shelf in a warehouse. The prompt 253 may accordingly include, for example, numbers, names of the items, time values, warehouse location identifiers (e.g., “shelf”, “zone”, “area”, or the like), English alphabet letters, responses (e.g., “yes” or “no”), some combination thereof.

Referring back to FIG. 2, the profile configuration module 104 may be implemented as part of a device (e.g., one of the distributed devices 122 of FIG. 1 or another computer device) that includes a display screen and/or an audio speaker. The profile configuration module 104 may visually display the prompt 253 and/or audibly display the prompt 253 to the user 137.

The user 137 may provide the spoken pronunciation 251 corresponding to the prompt 253. For instance, the prompt 253 may be displayed (visually or audibly) to the user 137 and the spoken pronunciation 251 is a statement or statements provided by the user 137 immediately following. The profile configuration module 104 may form a pairing between the prompt 253 and the spoken pronunciation 251. In some embodiments, the spoken pronunciation 251 may include two or more statements. For instance, the user 137 may provide a series of statements corresponding to the same displayed prompt 253. In these and other embodiments, the profile configuration module 104 may form a one-to-many pairing between the prompt 253 and the multiple statements. For example, the user 137 may state “yes,” “affirmative,” “okay,” “yeah,” or “uh-huh” in response to the prompt 253 including the word “yes.” The profile configuration module 104 may create a pairing of each of these statements with the prompt 253.

The profile configuration module 104 generates the vocal profile 206 corresponding to the user 137 based on the vocal configuration data 202. Because the spoken pronunciation 251 is associated with the user 137 and the spoken pronunciation 251 is pulled directly from the user 137, the profile configuration module 104 generates the vocal profile 206 that is unique or specific to the user 137.

The vocal profile 206 may be a user-specific grammar file that includes the pairings between the prompt 253 and the spoken pronunciation 251. In some embodiments, the profile configuration module 104 and/or the determination module 110 implements a Backus-Naur Form (BNF) syntax notation. Some additional details of BNF syntax notation may be found in the ENCYCLOPEDIA OF COMPUTER SCIENCE, Jan. 2003, pages 129-131, which is incorporated herein by reference.

The BNF syntax notation may provide a structure for the spoken pronunciation 251 included in the configuration data 202 and the vocal input 211 (described below). The BNF syntax notation specifies a set of branching derivation rules containing a series of non-terminal or terminal variables. In these and other embodiments, the prompt 253 may be related to one or more of the terminal variables in a particular BNF syntax notation. For example, the BNF syntax notation may relate to a multi-digit positive floating point number. The prompt 253 may include the numbers zero through nine, a negative symbol “-”, and a decimal symbol “.”. The spoken pronunciation 251 are associated with each portion of the prompt 253. The vocal profile 206 may accordingly include a BNF file with the associations between the terminal variables represented by the spoken pronunciation 251. Accordingly, the BNF file associates the user's pronunciation style with the user 137.

In some embodiments, the vocal profile 206 may utilize a direct association between the prompts 253 and the spoken pronunciation 251. In these and other embodiments, the vocal profile 206 may include a correlation table. The spoken pronunciation 251 may be received and, using a speech-to-text platform, may generate a corresponding text. The textual representation of the spoken pronunciation 251 may be associated with prompt 253.

In some embodiments, an expected pronunciation may be associated with the prompt 253. The expected pronunciation may be associated with a phonetic sound. In these and other embodiments, the profile configuration module 104 may compare the spoken pronunciation 251 with the phonetic sound of the expected pronunciation. Responsive to a determination that the spoken pronunciation 251 and the expected pronunciation include a threshold number of similarities, the profile configuration module 104 may generate the vocal profile 206 based at least in part on the expected pronunciation.

The vocal profile 206 may be associated with or uniquely associated with identifier information 208 of the user 137. In some embodiments, prior to providing the spoken pronunciation 251, the identifier information 208 may be received. As the vocal profile 206 is generated, the profile configuration module 104 may associate the identifier information 208 of the user 137 to the vocal profile 206.

After the vocal profile 206 is generated, the determination module 110 may be configured to obtain the identifier information 208. The identifier information 208 may include data or information that identifies the user 137, such as login credentials, a token, a biometric authentication, a certificate exchange, a multi-factor authentication, a password, etc. Responsive to receipt of the identifier information 208, the vocal profile 206 is communicated to the determination module 110 or the determination module 110 may retrieve the vocal profile 206.

The user 137 may provide vocal input 211, which may be received by the determination module 110. The determination module 110 may use the vocal profile 206 as a basis to interpret the vocal input 211. For instance, the determination module 110 may determine whether the vocal input 211 is similar to or matches at least a part of the vocal profile 206. For example, the vocal input 211 may be processed by a voice-to-text application. The resulting text may be compared to the spoken pronunciation 251 provided to generate the vocal profile 206. Responsive to a match or substantial match, the determination module 110 may return an output value 214. The output value 214 may be the prompt 253 paired with the matched spoken pronunciation 251. The output value 214 may be communicated to the processing engine 129.

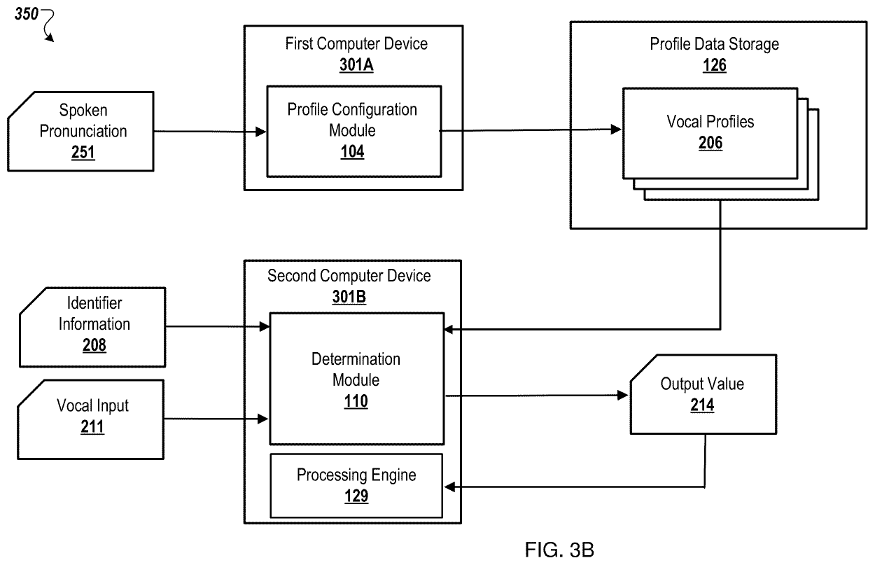

The determination module 110 may be implemented on the same computer system (e.g., one of the distributed devices 122 of FIG. 1) that implements the profile configuration module 104 or as part of a different computer system (e.g., two different distributed devices 122 or one of the distributed devices 122 and another computing device). For instance, FIG. 3A depicts an embodiment in which the determination module 110 and the profile configuration module 104 are implemented in the same computer system. FIG. 3B depicts an embodiment in which the determination module 110 and the profile configuration module 104 are implemented in different computer systems. Each of these embodiments are described below.

FIG. 3A is a block diagram of a single-device environment 300 in which the process 200 may be implemented. The single-device environment 300 includes a first computer device 301A that is communicatively coupled to the profile data storage 126. The profile data storage 126 is described with reference to FIG. 1. The first computer device 301A may be one of the distributed devices 122 or a general, hardware-based device such as the management device 121 of FIG. 1 (described below). In the single-device environment 300, the receipt of the spoken pronunciation 251 and the generation of the vocal profile 206 occurs on the same device as the receipt of the vocal input 211 and generation of the output value 214. Accordingly, the first computer device 301A includes the profile configuration module 104 and the determination module 110. The profile configuration module 104 generates the vocal profiles 206 and associates the vocal profiles 206 with specific users (e.g., 137 of FIG. 1). After the vocal profiles 206 are generated and associated with users, the determination module 110 may retrieve one of the vocal profiles 206 based on receipt of identifier information. The determination module 110 may use the retrieved vocal profile 206 to interpret the vocal input 211 and generate the output value 214.

FIG. 3B is a block diagram of a multi-device environment 350 in which the process 200 of FIG. 2 may be implemented. The multi-device environment 350 includes the first computer device 301A and a second computer device 301B that are communicatively coupled to the profile data storage 126. The profile data storage 126 is described with reference to FIG. 1. The first computer device 301A and the second computer device 301B may be one of the distributed devices 122 or the management device 121 of FIG. 1. In some embodiments of the multi-device environment 350, the first computer device 301A may be a general computing device that has loaded thereon the profile configuration module 104. The first computing device 301A in the multi-device environment 350 may not include a scanner device or may have limited functionality other than receipt of the spoken pronunciation 251 and generation of the vocal profiles 206.

The second computer device 301B includes the determination module 110 and may be configured to receive the identifier information 208 and the vocal input 211. The determination module 110 on the second computer device 301B may retrieve one of the vocal profiles 206 that is associated with one of the users who provided the identifier information 208. In the embodiment depicted in FIG. 3B, the second computer device 301B does not include the profile configuration module 104. In other embodiments, the second computer device 301B may include the profile configuration module 104 and perform one or more operations associated therewith.

Although the multi-device environment 350 is illustrated as including the first computer device 301A and the second computer device 301B, it may be understood with the benefit of the present disclosure that operating environments might include a third computer device, a fourth computer device, or any other quantities of computer devices may be used to perform the operations described with reference to FIGS. 1-3B.

The multi-device environment 350 may be used in situations in which a user configures their vocal profile 206 on the first computer device 301A. The user later uses the second computer device 301B, which is configured to establish an identity of the user based on the identifier information 208.

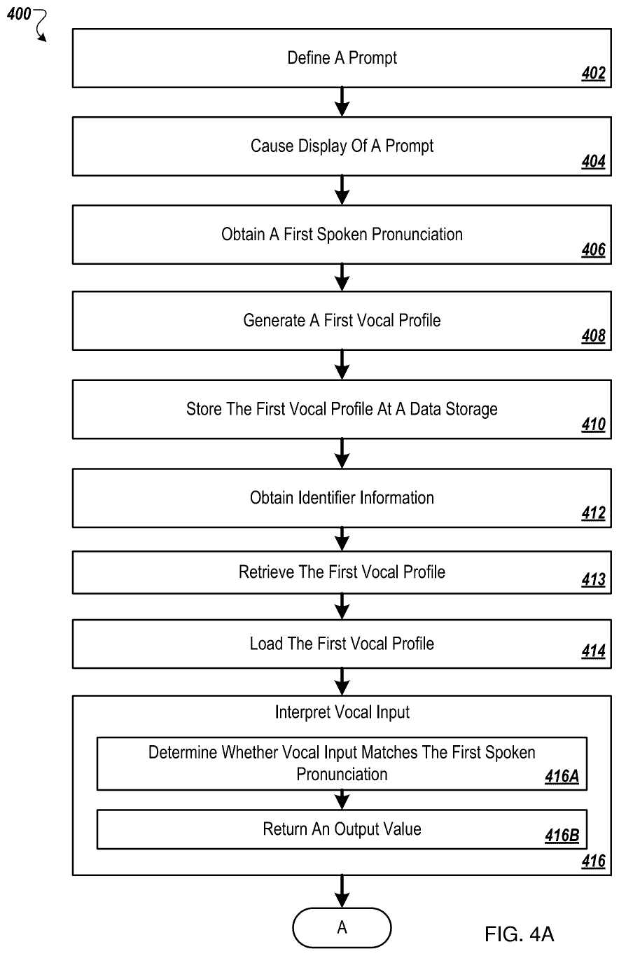

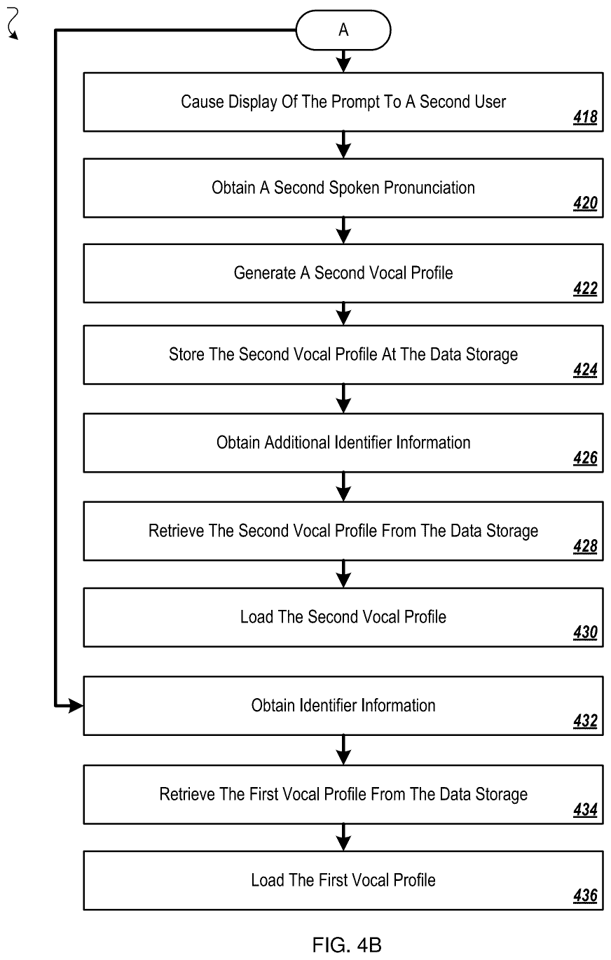

FIGS. 4A and 4B are a flow chart of an example method 400 of vocal profile generation and implementation, according to at least one embodiment of the present disclosure. The method 400 may be performed in a suitable operating environment such as the operating environment 120 of FIG. 1.

With reference to FIG. 4A, the method 400 may being at block 402 in which a prompt may be defined. The prompt may be defined based on anticipated input to a processing engine executable by one or more distributed devices. For instance, the distributed devices may be configured for use in a warehouse operations environment. The prompt may represent an input value of the processing engine such as alpha-numeric values, locations in a warehouse, commands to move through user interface pages, etc. The processing engine may be configured to receive the input value representative of the vocal input, to convert the input value representative of the vocal input to another data format protocol, and to communicate the converted data from the first distributed device to a server device. At block 404, display of a prompt may be caused. The prompt may be displayed for a first user. The prompt may include an alphanumerical symbol representative of the anticipated input to the processing engine.

At block 406, a first spoken pronunciation may be obtained. The first spoken pronunciation may be obtained from the first user. The first spoken pronunciation may correspond to the prompt. At block 408, a first vocal profile may be generated. The first vocal profile may be generated based at least partially on the first spoken pronunciation. The first vocal profile may provide a basis for interpretation of vocal input received on any of the distributed devices. In some embodiments, a Backus-Naur Form (BNF) grammar file may be generated in which the first spoken pronunciation is paired as an equivalent alternative value to the prompt. In these and other embodiments, the first vocal profile may be based on the BNF grammar file. Additionally, in some embodiments, an expected pronunciation may be associated with the prompt. The expected pronunciation may be associated with a phonetic sound. In these and other embodiments, the first spoken pronunciation may be compared with the phonetic sound of the expected pronunciation. It may be determined that the first spoken pronunciation and the expected pronunciation include a threshold number of similarities. Responsive to the first spoken pronunciation and the expected pronunciation including the threshold number of similarities, the first vocal profile may be generated based at least partially on the expected pronunciation.

At block 410, the first vocal profile may be stored at a data storage with multiple other vocal profiles generated for users. At block 412, identifier information may be obtained. The identifier information may be obtained from a first distributed device. The identifier information is any data or information sufficient to indicate that the first user is operating the first distributed device. At block 413, the first vocal profile may be retrieved. The first vocal profile may be retrieved from the data storage. The first vocal profile may be retrieved from the data storage responsive to the identifier information.

At block 414, the first vocal profile may be loaded. The first vocal profile may be loaded onto the first distributed device such that vocal input obtained at the first distributed device during its operation by the first user is interpreted according to the first vocal profile prior to being communicated as an input value to the processing engine of the first distributed device. At block 416, vocal input may be interpreted. The vocal input may be interpreted according to the first vocal profile. In some embodiments, interpretation of the vocal input according to the first vocal profile includes determining whether the vocal input or a text-based representation of the vocal input substantially matches the first spoken pronunciation or a text-based representation of the first spoken pronunciation (block 416A in FIG. 4A) and returning an output value that corresponds to the input value of the prompt (block 416B in FIG. 4A).

Referring to FIG. 4B, the method 400 may proceed from block 416 to block 418 or 432 based on activities of an environment in which the method 400 is implemented. At block 418, display of the prompt may be caused to a second user. At block 420, a second spoken pronunciation may be obtained. The second spoken pronunciation may be obtained from the second user corresponding to the prompt. At block 422, a second vocal profile may be generated. The second vocal profile may be generated based at least partially on the second spoken pronunciation. The second vocal profile may provide a basis for an additional interpretation of vocal input on the first distributed device.

At block 424, the second vocal profile may be stored. The second vocal profile may be stored at the data storage with other vocal profiles. At block 426, additional identifier information may be obtained. The additional identifier information may be any data or information sufficient to indicate that the second user is operating the first distributed device.

At block 428, the second vocal profile may be retrieved from the data storage. The second vocal profile may be retrieved responsive to the additional identifier information. At block 430, the second vocal profile may be loaded onto the first distributed device such that vocal input obtained at the distributed device during its operation by the second user is interpreted according to the second vocal profile. In some embodiments, the prompt may be displayed on the first distributed device to the first user and the second user. Additionally, the first spoken pronunciation and the second spoken pronunciation may be received at the first distributed device. Additionally still, the identifier information and the additional identifier information may be received at the first distributed device.

At block 432, the identifier information may be obtained. The identifier information may be obtained from a second distributed device. The identifier information may include any data or information sufficient to indicate that the first user is operating the second distributed device. At block 434, the first vocal profile may be retrieved from the data storage. The first vocal profile may be retrieved from the data storage responsive to the identifier information. At block 436, the first vocal profile may be loaded onto the second distributed device such that vocal input obtained at the second distributed device during its operation by the first user is interpreted according to the first vocal profile.

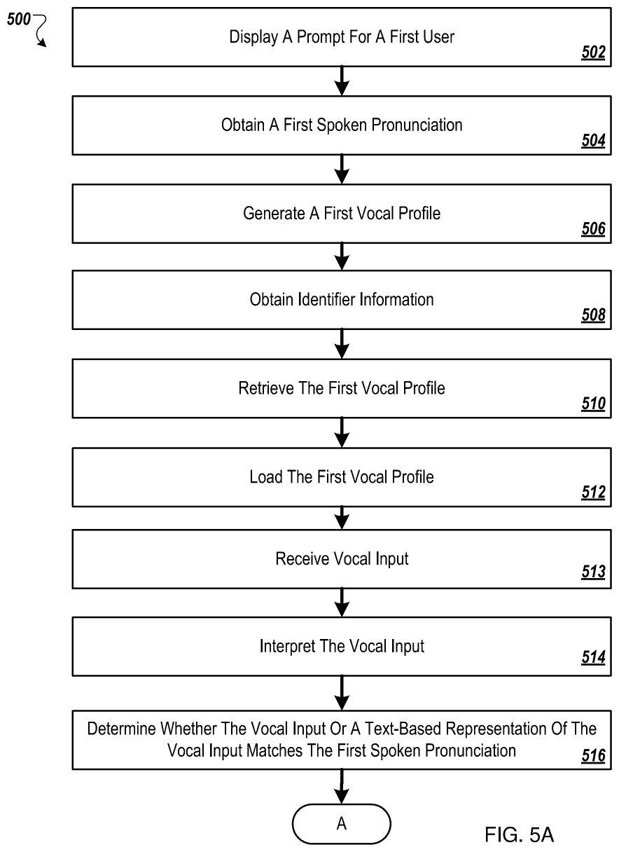

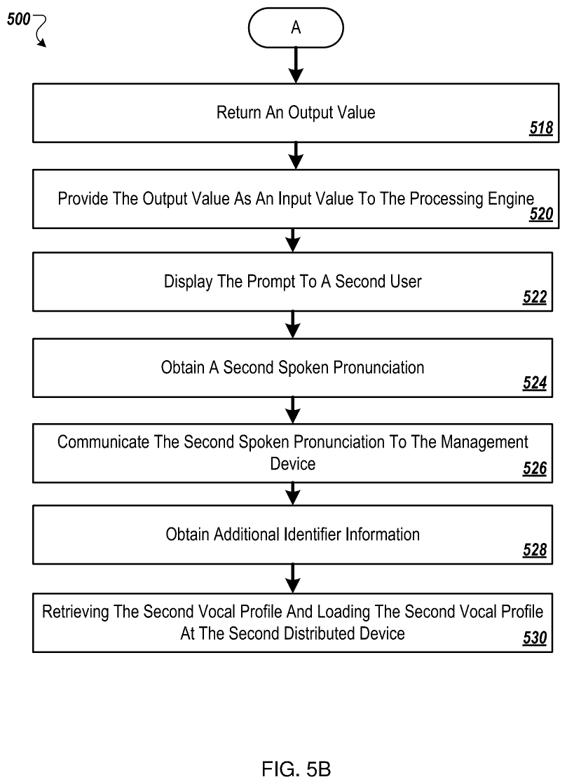

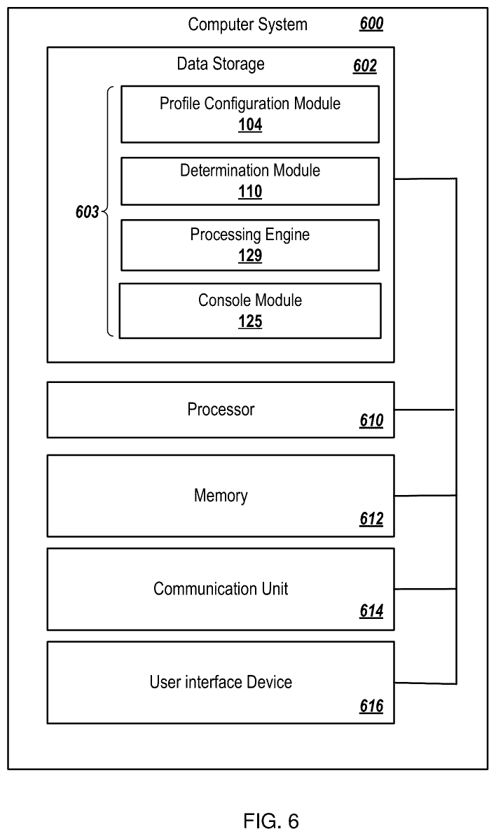

FIGS. 5A and 5B are a flow chart of an example method 500 of vocal profile generation and implementation, according to at least one embodiment of the present disclosure. The method 500 may be performed in a suitable operating environment such as the operating environment 120 of FIG. 1.

With reference to FIG. 5A, the method 500 may begin at block 502 in which a prompt may be displayed. The prompt may be displayed for a first user. The prompt may be displayed at a first distributed device of multiple distributed devices. The prompt may represent an input value of a processing engine executable at the distributed devices. In some embodiments, the prompt may include an alphanumerical symbol representative of an anticipated input to the processing engine. Additionally, in some embodiments, the distributed devices may be configured for use in a warehouse operations environment. The processing engine may be configured to receive the input value representative of vocal input, to convert the input value representative of the vocal input to another data format protocol, and to communicate the converted data from the first distributed device to a server device.

At block 504, a first spoken pronunciation may be obtained. The first spoken pronunciation may be obtained at the first distributed device from the first user. The first spoken pronunciation may correspond to the prompt. At block 506, a first vocal profile may be generated. The first vocal profile may be generated by the first distributed device. The first vocal profile may be based at least partially on the first spoken pronunciation. The first vocal profile may provide a basis for interpretation of vocal input received by the distributed devices. In some embodiments, the first vocal profile is based on a Backus-Naur Form (BNF) grammar file in which the first spoken pronunciation is paired as an equivalent alternative value to the prompt. In these and other embodiments, the first vocal profile is based on BNF grammar file.

In some embodiments, an expected pronunciation is associated with the prompt. The expected pronunciation may be associated with a first phonetic sound. In these and other embodiments, the method 500 may include comparing the first spoken pronunciation with the first phonetic sound of the expected pronunciation. The method may include determining that the first spoken pronunciation and the expected pronunciation include a threshold number of similarities and responsive to the first spoken pronunciation and the expected pronunciation include the threshold number of similarities, the first vocal profile is based at least partially on the expected pronunciation and the first spoken pronunciation.

At block 508, identifier information may be obtained. The identifier information may be obtained at a second distributed device. The identifier information may include any data or information sufficient to indicate that the first user is operating the second distributed device. At block 510, the first vocal profile may be retrieved. The first vocal profile may be retrieved responsive to the identifier information. At block 512, the first vocal profile may be loaded onto the second distributed device. At block 513, vocal input may be received. The vocal input may be received from the first user at the second distributed device.

At block 514, the vocal input may be interpreted. The vocal input may be interpreted according to the first vocal profile. The vocal input may be interpreted according to the first vocal profile by the second distributed device. At block 516, it may be determined whether the vocal input or a text-based representation of the vocal input matches the first spoken pronunciation.

Referring to FIG. 5B, at block 518, an output value may be returned. The output value may be returned responsive to the vocal input or a text-based representation of the vocal input matching the first spoken pronunciation. The output value may correspond to the input value of the prompt. At block 520, the output value may be provided as an input value to the processing engine. At block 522, the prompt may be displayed to a second user. The prompt may be displayed to a second user at the first distributed device. At block 524, a second spoken pronunciation may be obtained. The second spoken pronunciation may be obtained from the second user. The second spoken pronunciation may correspond to the prompt.

At block 526, the second spoken pronunciation may be communicated to the management device. The second spoken pronunciation may be communicated to the management device such that a second vocal profile is generated based at least partially on the second spoken pronunciation. The second vocal profile may provide a basis for interpretation of vocal input received by the distributed devices.

At block 528, additional identifier information may be obtained. The additional identifier information may be obtained at the second distributed device. The additional identifier information may include data and information sufficient to indicate that the second user is operating the second distributed device. At block 530, the second vocal profile may be retrieved. The second vocal profile may be retrieved responsive to the identifier information. The second vocal profile may be loaded at the second distributed device to enable interpretation of vocal input received at the second distributed device based on the second vocal profile. For instance, the interpretation of the vocal input may be based on a similarity between the received vocal input and the second spoken pronunciation.

The methods 400 and 500 may be performed by the distributed devices 122 or the management device 121 described elsewhere in the present disclosure or by another suitable computing system, such as the computer system 600 of FIG. 6. In some embodiments, the distributed devices 122, the management device 121, or the other computing system may include or may be communicatively coupled to a non-transitory computer-readable medium (e.g., the memory 612 of FIG. 6) having stored thereon programming code or instructions that are executable by one or more processors (such as the processor 610 of FIG. 6) to cause the distributed devices 122, the management device 121, or the other suitable computing system to perform or control performance of the methods 400 and 500. Additionally or alternatively, the distributed devices 122, the management device 121, or the other suitable computing system may include the processor 610 that is configured to execute computer instructions to cause the distributed devices 122, the management device 121, or the other suitable computing system to perform or control performance of the methods 400 and 500. The distributed devices 122, the management device 121, or the computer system 600 implementing the methods 400 and 500 may be included in a cloud-based managed network, an on-premises system, or another suitable network computing environment. Although illustrated as discrete blocks, one or more blocks in FIGS. 4A-5B may be divided into additional blocks, combined into fewer blocks, or eliminated, depending on the desired implementation.

Further, modifications, additions, or omissions may be made to the methods 400 and 500 without departing from the scope of the present disclosure. For example, the operations of methods 400 and 500 may be implemented in differing order. Furthermore, the outlined operations and actions are only provided as examples, and some of the operations and actions may be optional, combined into fewer operations and actions, or expanded into additional operations and actions without detracting from the disclosed embodiments.

FIG. 6 illustrates an example computer system 600 configured for vocal profile generation and implementation. The computer system 600 may be implemented in the operating environment 120 of FIG. 1, for instance. Examples of the computer system 600 may include the distributed devices 122, the server device 123, the management device 121, the computer devices 301A and 301B, or some combination thereof. The computer system 600 may include one or more processors 610, a memory 612, a communication unit 614, a user interface device 616, and a data storage 602 that includes one or more or a combination of the profile configuration module 104, the determination module 110, the processing engine 129, and the console module 125 (collectively, system modules 603).

The processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 6, the processor 610 may more generally include any number of processors configured to perform individually or collectively any number of operations described in the present disclosure. Additionally, one or more of the processors 610 may be present on one or more different electronic devices or computing systems. In some embodiments, the processor 610 may interpret and/or execute program instructions and/or process data stored in the memory 612, the data storage 602, or the memory 612 and the data storage 602. In some embodiments, the processor 610 may fetch program instructions from the data storage 602 and load the program instructions in the memory 612. After the program instructions are loaded into the memory 612, the processor 610 may execute the program instructions.

The memory 612 and the data storage 602 may include computer-readable storage media for carrying or having computer-executable instructions or data structures stored thereon. Such computer-readable storage media may include any available media that may be accessed by a general-purpose or special-purpose computer, such as the processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

The communication unit 614 may include one or more pieces of hardware configured to receive and send communications. In some embodiments, the communication unit 614 may include one or more of an antenna, a wired port, and modulation/demodulation hardware, among other communication hardware devices. In particular, the communication unit 614 may be configured to receive a communication from outside the computer system 600 and to present the communication to the processor 610 or to send a communication from the processor 610 to another device or network (e.g., the profile data storage 126 of FIG. 1).

The user interface device 616 may include one or more pieces of hardware configured to receive input from and/or provide output to a user. In some embodiments, the user interface device 616 may include one or more of a speaker, a microphone, a display, a keyboard, a touch screen, or a holographic projection, among other hardware devices.

The system modules 603 may include program instructions stored in the data storage 602. The processor 610 may be configured to load the system modules 603 into the memory 612 and execute the system modules 603. Alternatively, the processor 610 may execute the system modules 603 line-by-line from the data storage 602 without loading them into the memory 612. When executing the system modules 603, the processor 610 may be configured to perform one or more processes or operations described elsewhere in this disclosure.

Modifications, additions, or omissions may be made to the computer system 600 without departing from the scope of the present disclosure. For example, in some embodiments, the computer system 600 may not include the user interface device 616. In some embodiments, the different components of the computer system 600 may be physically separate and may be communicatively coupled via any suitable mechanism. For example, the data storage 602 may be part of a storage device that is separate from a device, which includes the processor 610, the memory 612, and the communication unit 614, that is communicatively coupled to the storage device. The embodiments described herein may include the use of a special-purpose or general-purpose computer including various computer hardware or software modules.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of vocal profile generation and implementation, the method comprising:
causing display of a prompt for a first user, the prompt representing an input value of a processing engine executable by a plurality of distributed devices;
obtaining a first spoken pronunciation from the first user that corresponds to the prompt;
generating a first vocal profile based at least partially on the first spoken pronunciation, the first vocal profile providing a basis for interpretation of vocal input received on any distributed device of the plurality of distributed devices;
storing the first vocal profile at a data storage with a plurality of vocal profiles generated for a plurality of users;
obtaining, from the first distributed device, identifier information sufficient to indicate that the first user is operating a first distributed device of the plurality of distributed devices;
responsive to the identifier information, retrieving the first vocal profile from the data storage; and
loading the first vocal profile onto the first distributed device such that vocal input obtained at the first distributed device during its operation by the first user is interpreted according to the first vocal profile prior to being communicated as an input value to the processing engine of the first distributed device.

2. The method of claim 1, wherein interpretation of the vocal input according to the first vocal profile includes:
determining whether the vocal input or a text-based representation of the vocal input substantially matches the first spoken pronunciation or a text-based representation of the first spoken pronunciation; and
returning an output value that corresponds to the input value of the prompt.

3. The method of claim 1, further comprising:
causing display of the prompt to a second user;
obtaining a second spoken pronunciation from the second user corresponding to the prompt;
generating a second vocal profile based at least partially on the second spoken pronunciation, the second vocal profile providing a basis for an additional interpretation of vocal input on the first distributed device;
storing the second vocal profile at the data storage with the plurality of vocal profiles;
obtaining additional identifier information sufficient to indicate that the second user is operating the first distributed device;
responsive to the additional identifier information, retrieving the second vocal profile from the data storage; and
loading the second vocal profile onto the first distributed device such that vocal input obtained at the distributed device during its operation by the second user is interpreted according to the second vocal profile.

4. The method of claim 3, wherein:
the prompt is displayed on the first distributed device;
the first spoken pronunciation and the second spoken pronunciation are received at the first distributed device; and
the identifier information and the additional identifier information are received at the first distributed device.

5. The method of claim 1, further comprising generating a Backus-Naur Form (BNF) grammar file in which the first spoken pronunciation is paired as an equivalent alternative value to the prompt, wherein the first vocal profile is based on the BNF grammar file.

6. The method of claim 1, wherein:
an expected pronunciation is associated with the prompt; and
the expected pronunciation is associated with a phonetic sound.

7. The method of claim 6, further comprising:
comparing the first spoken pronunciation with the phonetic sound of the expected pronunciation;
determining that the first spoken pronunciation and the expected pronunciation include a threshold number of similarities; and
responsive to the first spoken pronunciation and the expected pronunciation include the threshold number of similarities, generating the first vocal profile based at least partially on the expected pronunciation.

8. The method of claim 1, further comprising:
obtaining, from a second distributed device of the plurality of distributed devices, identifier information sufficient to indicate that the first user is operating the second distributed device of the plurality of distributed devices;
responsive to the identifier information, retrieving the first vocal profile from the data storage; and
loading the first vocal profile onto the second distributed device such that vocal input obtained at the second distributed device during its operation by the first user is interpreted according to the first vocal profile.

9. The method of claim 1, wherein:
the plurality of distributed devices is configured for use in a warehouse operations environment; and
the processing engine is configured to receive the input value representative of the vocal input, to convert the input value representative of the vocal input to another data format protocol, and to communicate the converted data from the first distributed device to a server device.

10. The method of claim 1, wherein the prompt includes an alphanumerical symbol representative of an anticipated input to the processing engine.

11. One or more non-transitory computer-readable storage media configured to store instructions that, in response to being executed, cause a system to perform operations of vocal profile generation and implementation, the operations comprising:
causing display of a prompt for a first user, the prompt representing an input value of a processing engine executable by a plurality of distributed devices;
obtaining a first spoken pronunciation from the first user that corresponds to the prompt;
generating a first vocal profile based at least partially on the first spoken pronunciation, the first vocal profile providing a basis for interpretation of vocal input received on any distributed device of the plurality of distributed devices;
storing the first vocal profile at a data storage with a plurality of vocal profiles generated for a plurality of users;
obtaining, from the first distributed device, identifier information sufficient to indicate that the first user is operating a first distributed device of the plurality of distributed devices;
responsive to the identifier information, retrieving the first vocal profile from the data storage; and
loading the first vocal profile onto the first distributed device such that vocal input obtained at the first distributed device during its operation by the first user is interpreted according to the first vocal profile prior to being communicated as an input value to the processing engine of the first distributed device.

12. The one or more non-transitory computer-readable storage media of claim 11, wherein interpretation of the vocal input according to the first vocal profile includes:
determining whether the vocal input or a text-based representation of the vocal input substantially matches the first spoken pronunciation or a text-based representation of the first spoken pronunciation; and
returning an output value that corresponds to the input value of the prompt.

13. The one or more non-transitory computer-readable storage media of claim 11, wherein the operations further comprising:
causing display of the prompt to a second user;
obtaining a second spoken pronunciation from the second user corresponding to the prompt;
generating a second vocal profile based at least partially on the second spoken pronunciation, the second vocal profile providing a basis for an additional interpretation of vocal input on the first distributed device;
storing the second vocal profile at the data storage with the plurality of vocal profiles;
obtaining additional identifier information sufficient to indicate that the second user is operating the first distributed device;
responsive to the additional identifier information, retrieving the second vocal profile from the data storage; and
loading the second vocal profile onto the first distributed device such that vocal input obtained at the distributed device during its operation by the second user is interpreted according to the second vocal profile.

14. The one or more non-transitory computer-readable storage media of claim 13, wherein:
the prompt is displayed on the first distributed device;
the first spoken pronunciation and the second spoken pronunciation are received at the first distributed device; and
the identifier information and the additional identifier information are received at the first distributed device.

15. The one or more non-transitory computer-readable storage media of claim 11, wherein the operations further comprise generating a Backus-Naur Form (BNF) grammar file in which the first spoken pronunciation is paired as an equivalent alternative value to the prompt, wherein the first vocal profile is based on the BNF grammar file.

16. The one or more non-transitory computer-readable storage media of claim 11, wherein:
an expected pronunciation is associated with the prompt; and
the expected pronunciation is associated with a phonetic sound.

17. The one or more non-transitory computer-readable storage media of claim 16, further comprising:
comparing the first spoken pronunciation with the phonetic sound of the expected pronunciation;
determining that the first spoken pronunciation and the expected pronunciation include a threshold number of similarities; and
responsive to the first spoken pronunciation and the expected pronunciation include the threshold number of similarities, generating the first vocal profile based at least partially on the expected pronunciation.

18. The one or more non-transitory computer-readable storage media of claim 11, further comprising:
obtaining, from a second distributed device of the plurality of distributed devices, identifier information sufficient to indicate that the first user is operating the second distributed device of the plurality of distributed devices;
responsive to the identifier information, retrieving the first vocal profile from the data storage; and
loading the first vocal profile onto the second distributed device such that vocal input obtained at the second distributed device during its operation by the first user is interpreted according to the first vocal profile.

19. The one or more non-transitory computer-readable storage media of claim 11, wherein:
the plurality of distributed devices is configured for use in a warehouse operations environment; and
the processing engine is configured to receive the input value representative of the vocal input, to convert the input value representative of the vocal input to another data format protocol, and to communicate the converted data from the first distributed device to a server device.

20. The one or more non-transitory computer-readable storage media of claim 11, wherein the prompt includes an alphanumerical symbol representative of an anticipated input to the processing engine.
